(19) United States
(12) Patent Application Publication
(10) Pub. No.: US 2020/0057317 A1
(43) Pub. Date: Feb. 20, 2020

(54) HEAD UP DISPLAY COMBINER WITH DIMMABLE CONTROL

(71) Applicant: Visteon Global Technologies, Inc., Van Buren Township, MI (US)

(72) Inventors: Paul Fredrick Luther Weindorf, Novi, MI (US); Anne Sophie Gesine von Borstel, Karlsruhe (DE)

(21) Appl. No.: 16/102,848

(22) Filed: Aug. 14, 2018

(51) Int. Cl. G02F 1/01; G02B 27/01; B60K 35/00; B60K 37/02

(52) U.S. Cl. CPC G02F 1/0121; G02B 27/0101; B60K 35/00; B60K 37/02; B60K 2350/92; B60K 2350/2052; B60K 2350/2095; B60K 2350/352; B60K 2350/1072

(57) ABSTRACT

A head up display may include a combiner having a semi-transparent mirror to reflect light projected by a head up display light source. A dimmable element may be disposed adjacent to the combiner and opposite the semi-transparent mirror. The dimmable element may be configured to reduce the transmission of light reflected by the combiner through the dimmable element. The dimmable element may include a control system configured to reduce the transmission of light reflected by the combiner according to a plurality of light transmission reduction steps and may include a feedback control system configured to adjust the transmission of light through the dimmable element based on at least a light sensor and a light source measuring light transmission through the dimmable element.

### BACKGROUND

Head up displays for a vehicle are either projected onto a separate combiner or onto a windshield of the vehicle. Head up displays are often used in vehicles to provide information in the line of sight of the driver so that the driver does not have to look down to an instrument panel to view the information. The combiner is often placed beneath the vehicle windshield in front of the driver. The combiner provides a surface for a virtual image to be projected with information for the driver in the line of sight. The combiner can include vehicle information such as speed, engine speed (i.e., revolutions per minute), turn signal indicators, navigation directions, fuel/energy remaining, and status of vehicle lighting elements. By projecting the vehicle information onto the combiner, the driver does not have to look away from the light of sight to the vehicle instrument panel.

### SUMMARY

A head up display system is provided which includes a combiner having a semi-transparent mirror to reflect light (i.e., an image), projected by a head up display light source. A dimmable element is disposed adjacent to the combiner and opposite the semi-transparent mirror. The dimmable element is configured to reduce the transmission of light reflected by the combiner through the dimmable element. The dimmable element includes a control system configured to reduce the transmission of light reflected by the combiner according to a plurality of light transmission reduction steps and includes a feedback control system configured to adjust the transmission of light through the dimmable element based on at least a light sensor and a light source measuring light transmission through the dimmable element.

A head up display method is provided which includes reflecting light projected by a light source in a combiner having a semi-transparent mirror, measuring, using a light sensor, a transmission of light projected by the light source through a dimmable element adjacent to the combiner and opposite the semi-transparent mirror, comparing the measured transmission of light to a preset light transmission value, and reducing the transmission of light through the dimmable element to the preset light transmission value.

A non-transient computer readable medium containing program instructions for causing a computer to perform the method of configuring a combiner with a semi-transparent mirror, reflecting light projected by a light source with the combiner and the semi-transparent mirror, configuring a dimmable element adjacent to the combiner and opposite of the semi-transparent mirror, and reducing the transmission of light through the combiner through the dimmable element.

### BRIEF DESCRIPTION OF THE DRAWINGS

Further details, features and advantages of designs of the disclosure result from the following description of embodiment examples in reference to the associated drawings.

FIG. 1 is a cutaway view of a vehicle including an embodiment of a head up display combiner with dimmable control in accordance with the present disclosure;

FIG. 2 is a side view of a vehicle including an embodiment of a head up display combiner and illustrating a plurality of eye positions and virtual image positions in accordance with the present disclosure;

FIGS. 3A-3B are front views of embodiments head up display combiners in accordance with the present disclosure;

FIG. 4 is a front view of an embodiment of a head up display combiner in accordance with the present disclosure;

FIG. 5 is a graph illustrating the temperature dependence of light transmission versus drive voltage of an embodiment of a head up display combiner in accordance with the present disclosure;

FIG. 6 is an exemplary circuit diagram of a transmission feedback control system for use with an embodiment of a head up display combiner in accordance with the present disclosure;

FIGS. 7A-7D are side views of embodiments of head up display combiners in accordance with the present disclosure;

FIG. 8 is a block diagram of a digital, analog, or combination feedback control loop for an embodiment of a head up display combiner in accordance with the present disclosure;

FIG. 9 is a block diagram of a velocity form of the feedback control loop as shown in FIG. 8 for a head up display combiner in accordance with the present disclosure;

FIG. 10 is a chart illustrating the transmission levels for step numbers used in a transmission control system for an embodiment of a head up display combiner in accordance with the present disclosure;

FIG. 11 is a table illustrating a linear perception of a driver of the dimming control of an embodiment of a head up display combiner in accordance with the present disclosure;

FIG. 12 is a table illustrating an automatic luminance/dimming control of an embodiment of a head up display combiner in accordance with the present disclosure;

FIG. 13 is a block diagram illustrating an automatic display luminance system of an embodiment of a head up display combiner in accordance with the present disclosure;

FIG. 14 is a block diagram of an automatic display luminance system of FIG. 13 with logarithmic light sensors for use with an embodiment of a head up display combiner in accordance with the present disclosure; and

FIG. 15 is a block diagram of the automatic display luminance system of FIG. 14 that adjusts both the HUD luminance and combiner transmission instead of display for use with an embodiment of a head up display combiner in accordance with the present disclosure.

### DETAILED DESCRIPTION

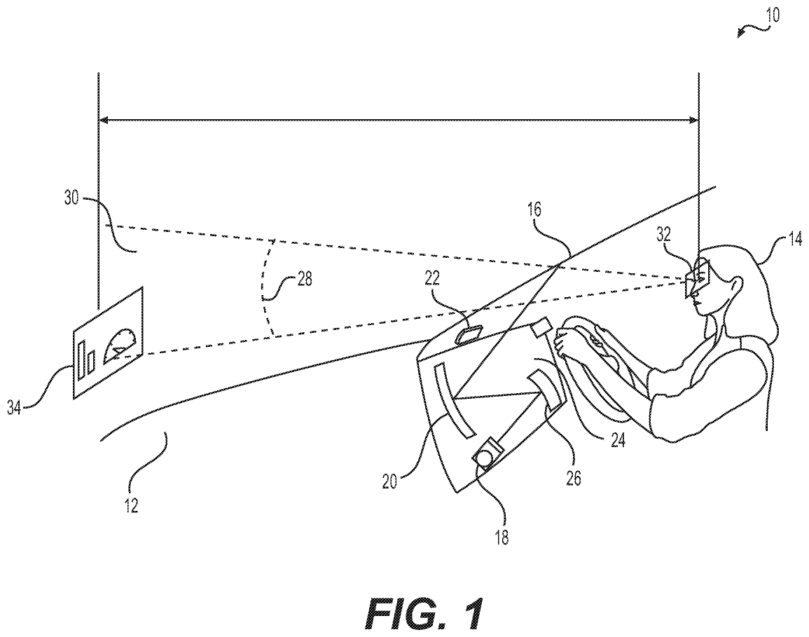

An embodiment of a head up display system (HUD) 10 is shown generally in FIG. 1. The HUD 10 is shown in a vehicle 12. A driver 14 may be positioned behind a windshield 16 of the vehicle 12 in view of the HUD 10. A HUD light source 18 may be disposed within the vehicle 12 and may be configured to project light (i.e., an image), onto a rotatable mirror 20. The HUD 10 may include a light trap 22, a glare trap 24, and/or a fold mirror 26. The view of the driver 14 includes an optical path 30 covering an angle 28 that may define the head motion range 32 of the driver 14. Within the head motion range 32 of the driver 14 may be the head up display image 34.

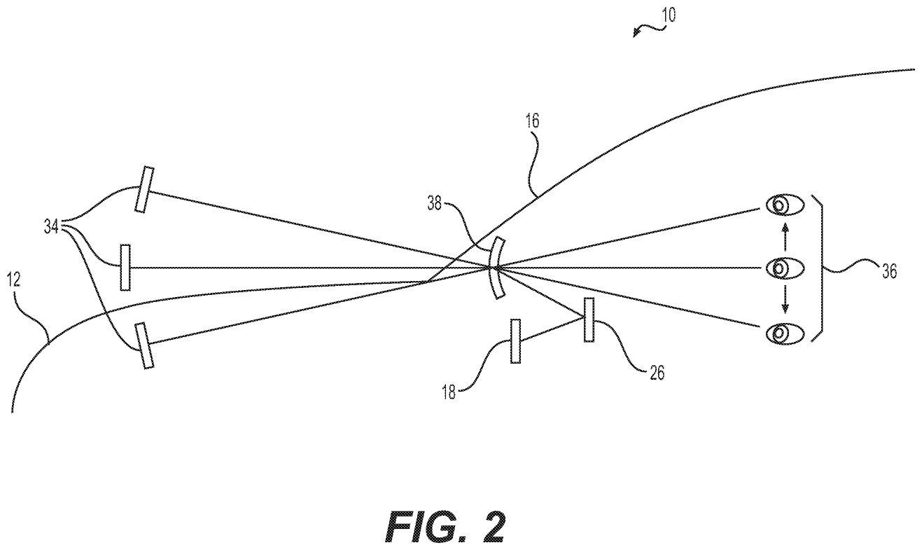

A HUD 10 may be projected via either a separate combiner 38 (see FIG. 2) or on the windshield 16. The HUD 10 may be provided so that that driver 14 does not have to significantly divert the eyes of the driver 14 “off the road” in order to see critical information such as vehicle speed, etc.

The emerging market of the HUD 10 in the automotive and other applications illustrates opportunities for one or more embodiments of dimmable optical components. The HUD 10 may generate a virtual image or images in front of the driver 14 that may be overlaid on the outside lighting environment. For example, the image may be either reflected directly by the windshield or by a semi-reflective combiner 38 that may be placed (i.e., disposed), in front of the windshield 16 (otherwise referred to as a combined HUD or CHUD).

In comparison with other information and/or navigation displays, the HUD 10 may show instantly-relevant information to the driver 14. With the HUD, the driver may not have to significantly divert his/her eyes in order to see the information. The HUD may, therefore, reduce eye fatigue, for the driver may not have to significantly divert his/her eyes.

However, the perception and accommodation of the eyes of the driver 14 may be disturbed by the visible background (i.e., the environment outside of the automobile). Further, due to the properties of the HUD 10, taller drivers may see (due to varied eye positions 36) the virtual image 34 generated by the HUD 10 that may be colliding with the engine hood of the vehicle 12 as shown in FIG. 2. Moreover, the lack of space between the windshield 16 and assembly space may result in a low-lying combiner 38 in the dashboard of the vehicle 12 (together with the HUD light source 18 (e.g., a thin film transistor (TFT)) and the fold mirror 26) that may lead to more interference of the virtual images 34 of the HUD 10 with the visible background.

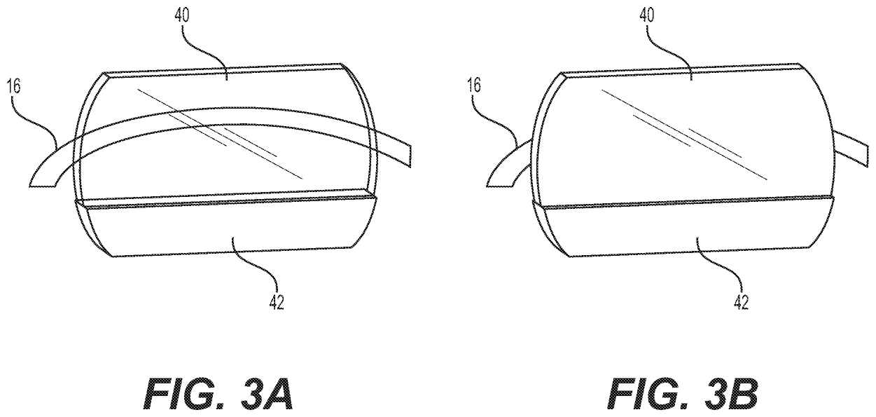

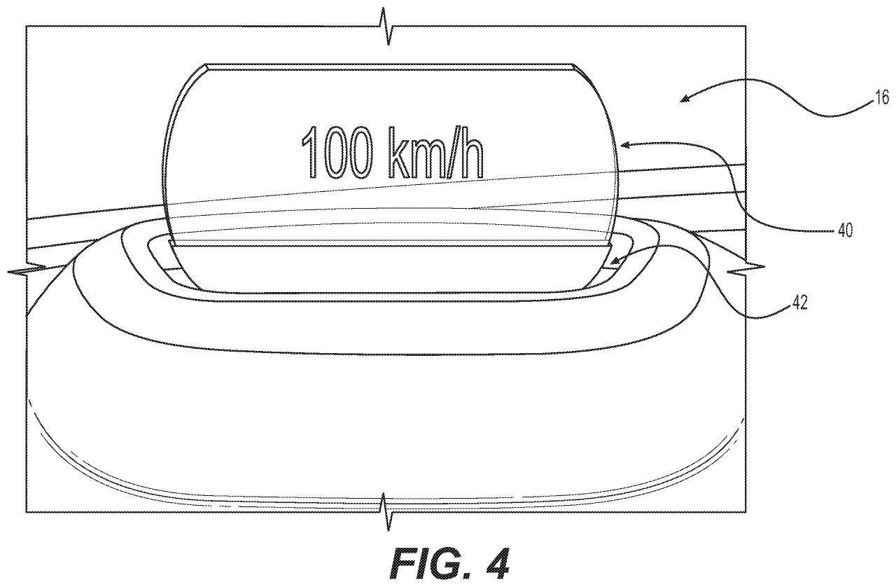

According to one or more embodiments, to overcome these issues it may be desirable to change the intensity of the background seen through the surface of the combiner 38. By replacing the common combiner 38 (as shown in FIG. 2) with a dimmable element 40, the transmission of light may be controlled as shown in FIGS. 3A-3B. FIG. 3A illustrates the dimmable element 40 in a transmissive state (i.e., lets light pass through) and FIG. 3B illustrates the dimmable element 40 in an opaque state (i.e., prevents at least some light passing through). By using the dimmable element 40 the driver 14 may manually adapt the transmitted light to the preferences of the driver 14. The dimmable element holder 42 may be configured to hide the electrical connection (and other components) of the dimmable element 40. FIG. 4 illustrates an exemplary combiner using the dimmable element 40 in the dimmed state mounted in the dimmable element holder 42.

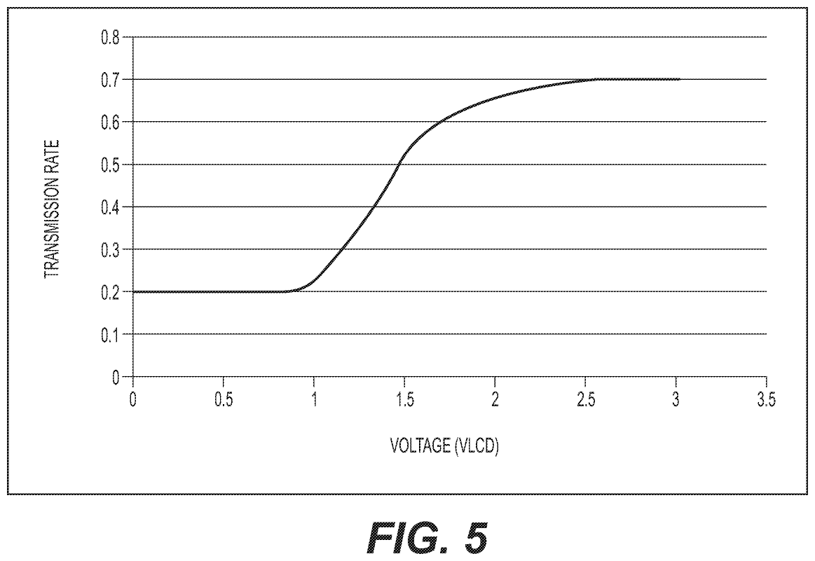

According to one or more embodiments, dimmable elements may be suspended particle devices (SPDs), electrochromic (EC) and dye-doped guest-host liquid crystal (LC) systems. All of these systems may need to be accurately driven to control the transmission rate of the dimmable element 40. As a non-limiting example, the embodiments may be illustrated herein using the dye-doped guest-host LC system. The guest-host LC system may have a transfer function that may vary as a function of temperature. Due to the temperature dependence of the transmission versus drive voltage as shown in FIG. 5, the transmission curve may shift left or right and also may change shape (i.e., its slope). Therefore, in order to accurately control the transmission rate of the dimmable element 40 and not experience temperature variations, a feedback control system may be needed.

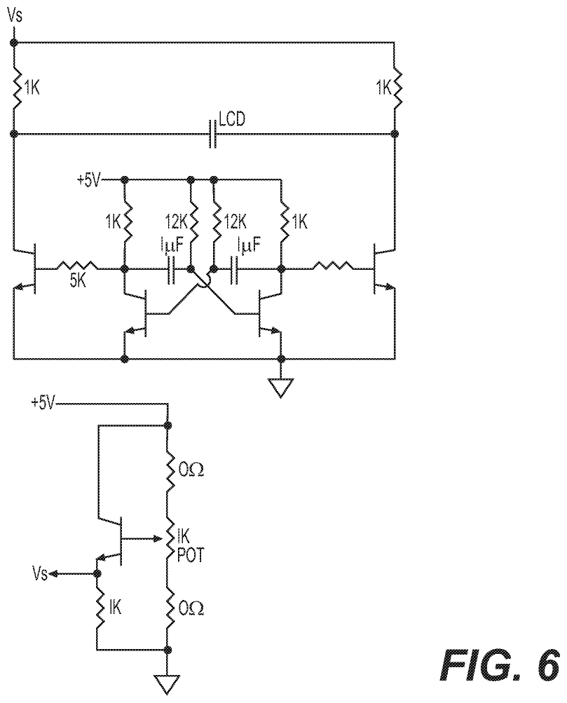

According to one or more embodiments, in order to accurately control the transmission level of the dimmable element 40, a feedback method may be employed. The drive (i.e., power supply), to the LC cell (dimmable element 40) may be alternating current (AC) in nature to prevent charge migration to one of the LC cell's internal surfaces. FIG. 6 illustrates an exemplary circuit according to one or more embodiment that may be used to drive the LC cell though other circuits may be used, including using two microprocessor counter outputs to generate the drive voltages to the final differential driving transistors (not shown). In FIG. 6, the peak-to-peak voltage may be controlled by Vs through a potentiometer circuit, but alternatively, the peak-to-peak voltage may be controlled by a pulse width modulator (PWM) output from a microprocessor with interface circuits (not shown).

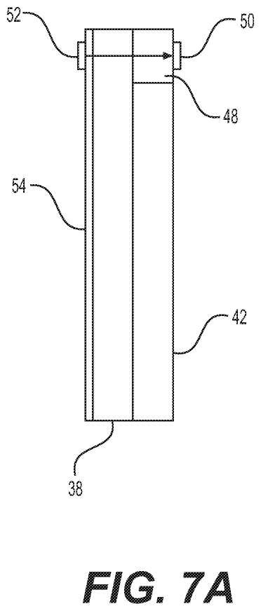

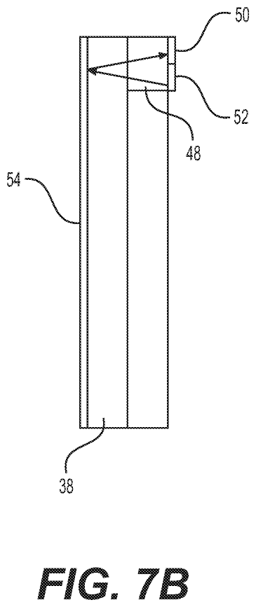

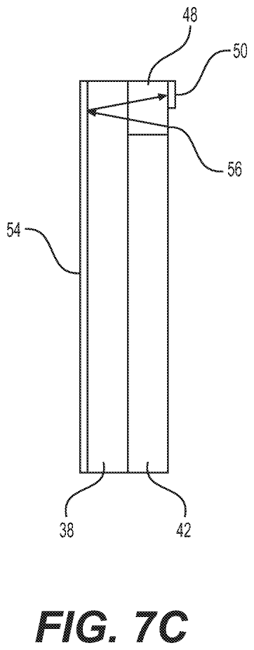

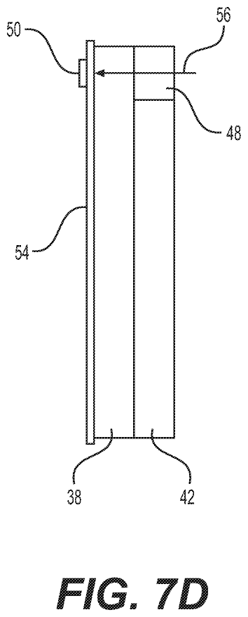

According to one or more embodiments shown in FIGS. 7A-7D disclose transmissive feedback dimming. Additionally, the transmissive feedback dimming may be applied to any optical structure (i.e., in addition to the HUD 10), capable of the dimming function.

According to one or more embodiments, the guest-host LC cell may be used or other structures capable of the dimming function (e.g., suspended particle devices (SPDs), electrochromic (EC) LC systems), since the measurement and control applies to other optical configurations capable of dimming. As shown in FIG. 5, the transfer function of an LC cell may be fairly steep and may vary with temperature. Since the transmission rate may vary significantly (left to right in FIG. 5) with temperature and LC cell-to-cell variation, a feedback control mechanism may be needed to maintain control of the transmission rate.

According to one or more embodiments, the transmission rate of the LC cell (dimmable element 40) may be measured and may be controlled using a feedback control system. FIG. 7A illustrates a transmission-based system according to one or more embodiments though similar configurations may be used for a reflection-based control system as shown in FIG. 7B. Referring to FIG. 7A, the combiner 38 may be disposed between the dimmable element 42 and a semi-transparent reflector 54. One of more light emitting diodes (LEDs) 52 may be disposed on the semi-transparent reflector, opposite of the combiner 38 and may be configured to emit light through at least one of the semi-transparent reflector 54, the combiner 38, a segment 48 of the dimmable element 42 to a light sensor 50. The LEDs 52 may be configured as visible or invisible spectral radiation LEDs. The separate segment 48 may be configured to be independently controlled and may be used to provide the maximum transmission rate. Referring to FIG. 7B, the LEDs 52 may be disposed adjacent to the light sensor 50 such that light emitted by the LEDs 52 may pass through the segment 48 of the dimmable element 42 first, followed by the combiner 38, may be reflected by the semi-transparent reflector 54, and may pass through the combiner 38 and the dimmable element 42 a second time before arriving at the light sensor 50. In an alternative embodiment, the segment 48 may be eliminated and the maximum transmission rate may be estimated or may be determined during power up of the HUD 10. FIGS. 7C and 7D may use the ambient light 56 coming from behind the dimmable element 42 to determine the transmission rate. Referring to FIG. 7C, the combiner 38 may be disposed between the dimmable element 42 and the semi-transparent reflector 54. Ambient light 56 may enter the segment 48 of the dimmable element 42, may pass through the combiner 38, and may be reflected by the semi-transparent reflector 54 back through the combiner 38 and the segment 48 to the light sensor 50. Referring to FIG. 7D, the combiner 38 may be disposed between the dimmable element 42 and the semi-transparent reflector 54, and the light sensor 50 may be disposed on the semi-transparent reflector 54, opposite of the combiner 38 such that the ambient light 56 may pass through the segment 48, the combiner 38, and the semi-transparent reflector 54 before entering the light sensor 50. It should be noted that other configurations of the exemplary elements illustrated in FIGS. 7A-7D are contemplated to measure the transmission of the dimmable element 42 optically.

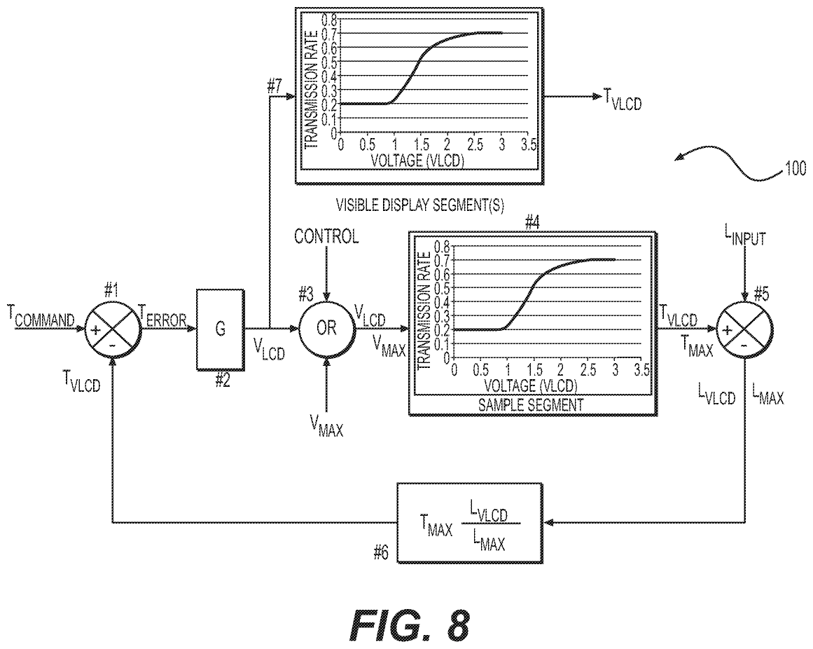

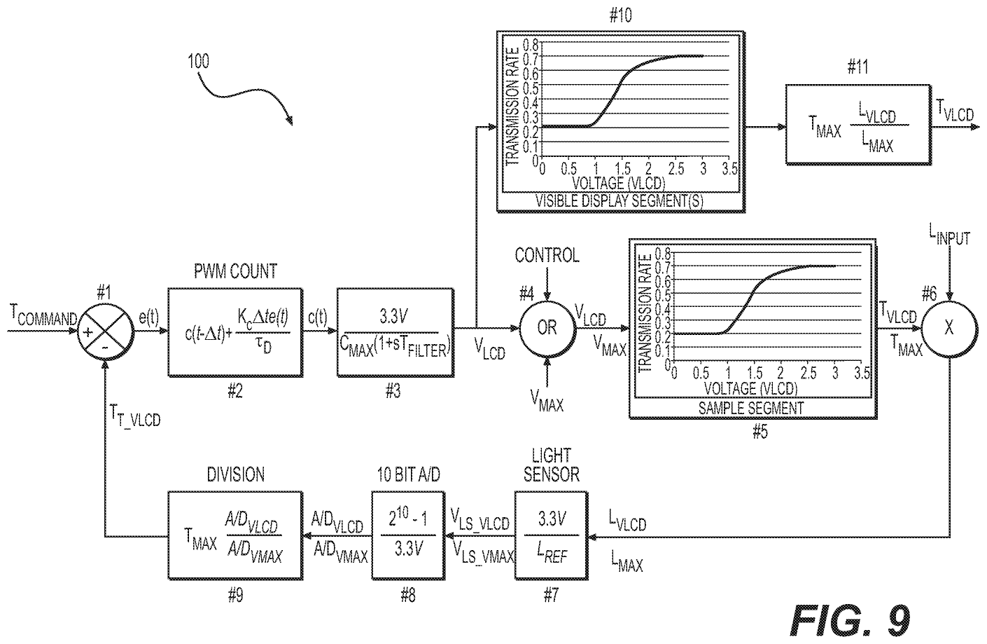

Referring now to FIG. 8, the LC voltage, V_{LCD}, may be adjusted to control the effective transmission rate using a feedback control loop 100. For example, the feedback control loop 100 may be either digital (proportional-integral-derivative or PID) or analog or a combination of both as shown in FIG. 9. The feedback control loop may accurately control the transmission value which starts in block 3 (see FIGS. 8-9). Block 3 may either apply the V_{LCD} voltage or the V_{MAX} voltage to the sample segment 48 in an alternating fashion. Block 4 may show the transmission transfer function for the exemplary guest-host LC cell (dimmable element 42). Therefore, when V_{LCD} may be applied to the sample segment 48 of the dimmable element 42, the transmission from the LEDs 52 (i.e., luminance), Lᵢₙₚᵤₜ in front of the sample segment 48 becomes T_{VLCD} which may result in the luminance L_{VLCD} being measured by the light sensor 50 in front of the sample segment 48 (see FIG. 7A). When the V_{MAX} voltage may be applied to the sample segment in Block 4, the transmission from the LEDs 52, Lᵢₙₚᵤₜ, may yield output luminance L_{MAX}. It should be noted that Block 5 may describe how the transmission factor of the guest-host LC cell may control the amount of light from the LEDs 52 that may be transmitted through the guest-host LC cell and may be essentially multiplicative in nature as shown in the following equations:

L_{VLCD}=T_{VLCD}×Lᵢₙₚᵤₜ

L_{MAX}=T_{MAX}×Lᵢₙₚᵤₜ

Therefore, by determining the luminance values from Block 5, the actual guest-host LC cell transmittance value may be determined by Block 6 using the following equation:

T_{VLCD}=T_{MAX}(L_{VLCD}/L_{MAX}).

According to one or more embodiments, by comparing the feedback transmittance, T_{VLCD} to the desired commanded reflectance, T_{COMMAND}, the transmittance error, T_{ERROR}, may be determined by Block 1 by subtracting T_{COMMAND} from T_{VLCD} in Block 1. Therefore, for example, if a higher transmittance is commanded, T_{ERROR} may increase thereby causing L_{VLCD} to increase. This may cause the desired result of increasing the transmittance in Block 6. It should be noted that the same V_{LCD} may be used to also drive the visible display segments of dimmable element 42 (adjacent to segment 48) in Block 7 thereby implementing the desired commanded transmittance, on the areas of the display visible to the driver 14.

According to one or more embodiments, the feedback control system may be configured in a PID-type feedback control system as illustrated in FIG. 9. It should be noted that the hub of the integration PID control feedback control loop may be found in Block 2 where a proportion of the error term (T_{ERROR}) may be added from the current control value. For example, if the error term is positive (+) the feedback transmittance value from Block 9 may be lower than the commanded reflectance value. Therefore, in order to increase the transmittance of the current commanded PWM count value, c(t), may be incremented by the second term in Block 2 until the error term is zero (0). It should be noted that the T_{MAX} in Block 9 may be in a percentage or another factor so that the count values may be constructed in whole numbers for simplicity of PID software implementation.

According to one or more embodiments, it should further be noted that although more accurate, the sample segment 48 may be not required. Alternatively, L_{MAX} may be sampled during power up (of the vehicle 12) and that value may be used for the remainder of the operational cycle (until the vehicle 12 is powered down). If during the operational cycle L_{MAX} may be commanded by the driver 14 of by the auto-dimming HUD 10, then the most recent L_{MAX} sample may be used by the PID loop (see FIGS. 8-9) for the remainder of the operational cycle.

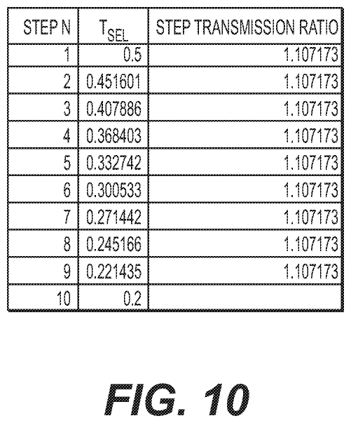

According to one or more embodiments, the automatic transmission control for the HUD 10 including the combiner 38 and the dimmable element 42 may be based on the HUD display (combiner 38) luminance increasing to a maximum value and then the dimmable element 42 (i.e., lens), transmission level may be adjusted for visibility of the driver 14. Under this embodiment the clearest dimmable element 42 may be utilized for various ambient lighting conditions. An additional aspect may be that ratio changes in transmission may appear as equal steps to the eyes of the driver 14 due to the logarithmic response nature of the eyes of the driver 14. Therefore, to construct automatic transmission control look up tables (see FIG. 10) the following equation may be used to determine the transmission rates as a function of the number of desired steps (e.g., 10 steps):

T_{SEL}=T_{MAX}/[T_{MAX}/T_{MIN}]^{[(N-1)/NT-1)]}, where

T_{SEL}=transmission of step number N;

T_{MAX}=maximum transmission level;

T_{MIN}=maximum transmission level;

N_{T}=total number of steps; and

N=selected step number.

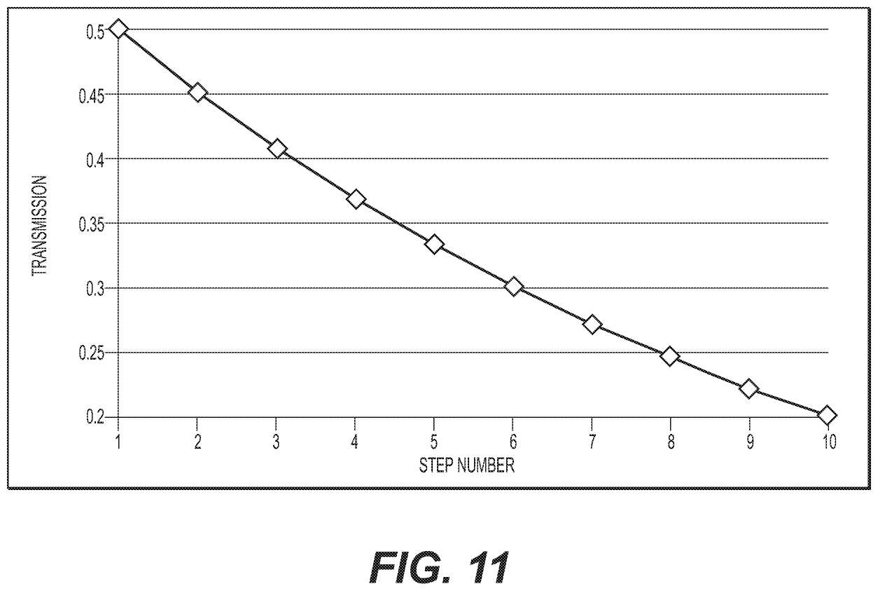

According to one or more embodiments, if a 10-step look up table were constructed the previous equation may be used to calculate the transmission levels for the various step numbers as shown in FIG. 10. It should be noted that the transmission ratio of successive steps as shown in FIG. 10 may be a constant value. In embodiments, the look up table shown in FIG. 10 may represent a manual transmission control table where the driver 14 may adjust the transmission level. Such a look up table may result in the driver 14 perceiving that the dimming control (of the dimmable element 42) may be linear in nature even though it is not as shown in the graph in FIG. 11.

According to one or more embodiments, the next step in constructing the automatic transmission control look up table may be to understand the function that relates display visibility to background luminance. The Silverstein visibility function, which relates the amount of required display luminance to the background luminance may be given by the following equation:

ESL=B_{O}(DBL)^{C}, where

ESL=Emitted Symbol Luminance in cd/m³;

B_{O}=Luminance Offset Constant;

DBL=Display Background Luminance in cd/m²; and

C=Power Constant (the slope of the power function in logarithmic coordinates).

According to one or more embodiments, the display background luminance (DBL) that the driver 14 sees on the combiner 38 may be a summation of the reflected background luminance (DBLR) and the transmitted background luminance (DBL_{T}). However, in the HUD 10, the transmitted background luminance may generally be much greater than the reflected background luminance and therefore the previous equation may be simplified to:

ESL=B_{O}(DBL_{T})^{C}.

According to one or more embodiments, for the combiner 38, the background luminance may be a function of the forward looking luminance (FLL) and the transmission (T) of the combiner 38 as shown in the following equation:

DBL_{T}=T×FLL.

Substituting the above equation into ESL=B_{O}(DBL_{T})^{C} yields:

ESL=B_{O}(T×FLL)^{C}.

Once the emitted symbol luminance (ESL) rises to a maximum value ESL_{MAX}, the dimmable combiner transmission may be reduced and therefore the previous equation may be rewritten as:

T=([ESL_{MAX}/B_{O}]\hat{ }(1/C))/FLL.

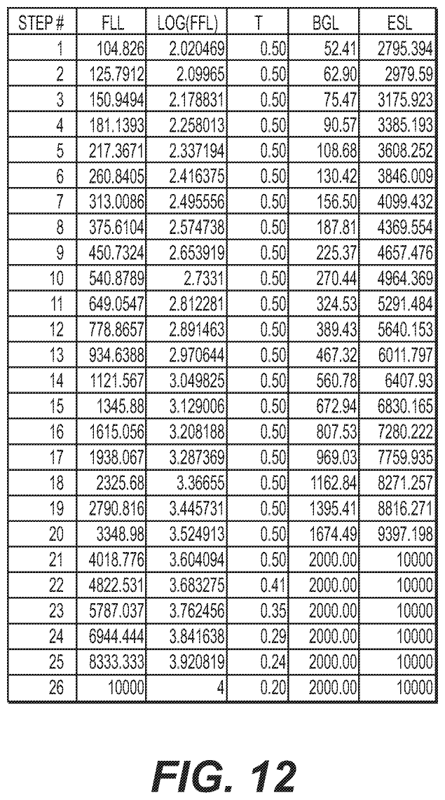

According to one or more embodiments, the previous equation may then used to construct the automatic luminance/dimming control look up table as shown in FIG. 12. The number of steps in the table (26) may be exemplary and may be dependent on how large the perceived control increments appear to the driver 14. As shown in the table of FIG. 12, a maximum HUD luminance of 10K cd/m² may be utilized in this example. In addition, the total combiner transmission range of 0.2 to 0.5 may be utilized. The visibility offset B_{O} (visibility index) may be calculated assuming the lowest combiner transmission and the maximum HUD luminance as shown in the following equation:

B_{O}=ESL_{MAX}/[T_{MIN}×FLL_{MAX}]^{0.35}=10000/[0.2×10000]^{0.35}=699.26.

According to one or more embodiments, the slope of 0.35 may be consistent (but slightly higher) than the Silverstein slope value of 0.273. Additionally, a maximum FLL of 10K cd/m² may be utilized to approximate the luminance of sunlight shining on a white shirt for the total scene average luminance. The FLL values may be constructed to be ratios in order to provide constant ESL ratios when the combiner transmission is a maximum value and to provide constant transmission ratios when the ESL is at a maximum value. This may result in constant differences between successive steps if a logarithmic type light sensor is used as shown in the “log(FLL)” column of the table in FIG. 12. A constant difference in the log(FLL) values may be preferred as this may be synonymous with equal analog/digital (A/D) converter values from the logarithmic forward looking light sensor (FLLS) which may be important not to run out of dynamic range. The combiner transmission values in FIG. 12 may be determined by using the following equation:

T=[[10000/699.26]^{(1/0.35)}]/FLL.

According to one or more embodiments, when the combiner 38 may be at the maximum transmission value of 0.5 for this example, the HUD ESL may be determined using the following equation:

ESL=699.26(0.5×FLL)^{0.35}.

According to one or more embodiments, a result of the table construction (see FIG. 12) may be that the use of a logarithmic light sensor not only provides constant A/D step increments, but may also result in both constant ESL steps and transmission ratio steps. In terms of the B_{O} offset constant 700 may result in a very visible HUD image performance as it may be higher than the perceptible level of about 44.3 as found by Silverstein.

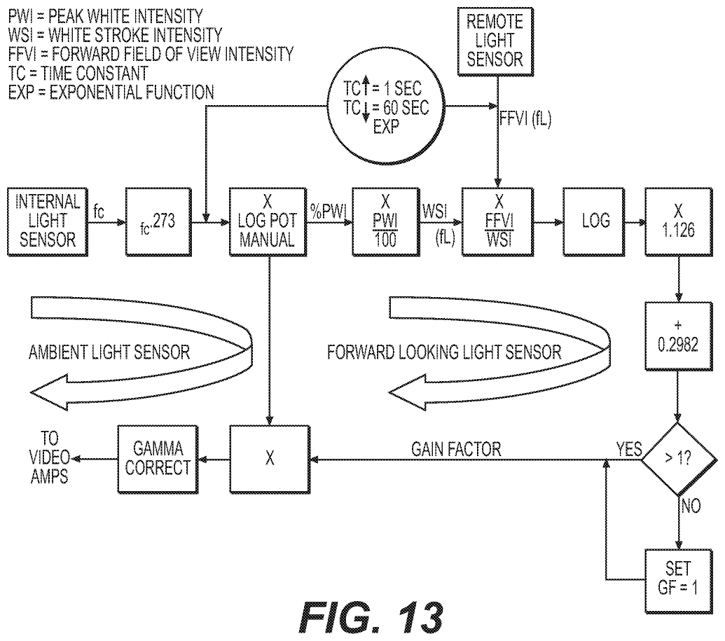

According to one or more embodiments, the final step in constructing the automatic transmission control look up table may be the realization that the Silverstein equation ESL=B_{O}(DBL_{T})^{C} only takes the background luminance into consideration. However, Silverstein also showed that the forward looking luminance also may be considered. In addition to increasing the display luminance as a function of the display background luminance measured by the internal light sensor (ambient light sensor) as shown in FIG. 13, display visibility performance may be improved by utilizing a forward looking (remote light sensor) as shown in FIG. 13 to compensate for conditions of transient adaptation or eye adaptation mismatch. However, unlike the work of Silverstein, both the HUD combiner background luminance adjusted by the combiner transmission value and the forward looking luminance may be measured by the same logarithmic forward looking light sensor.

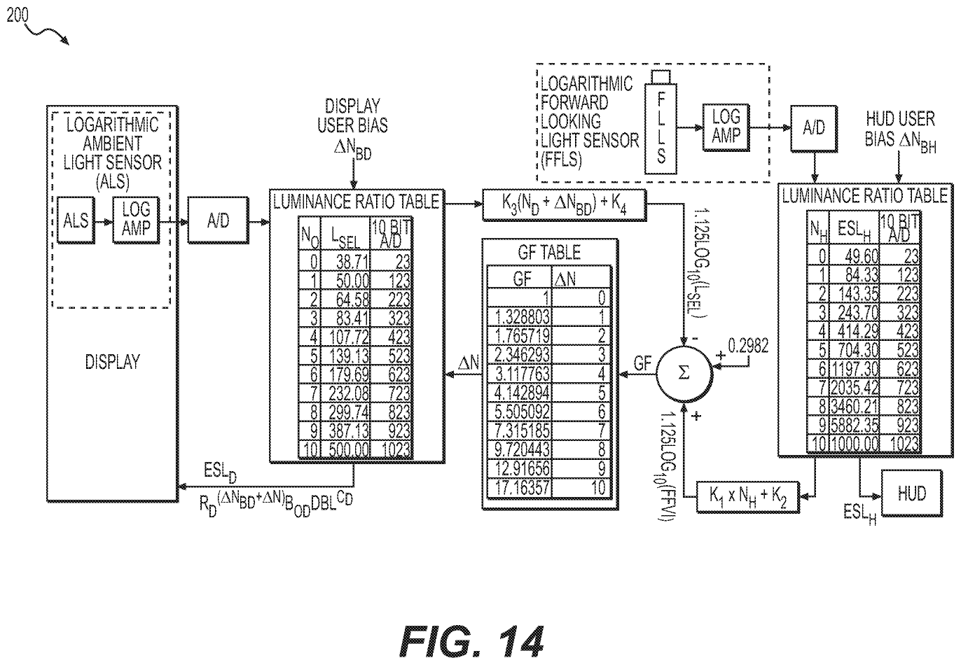

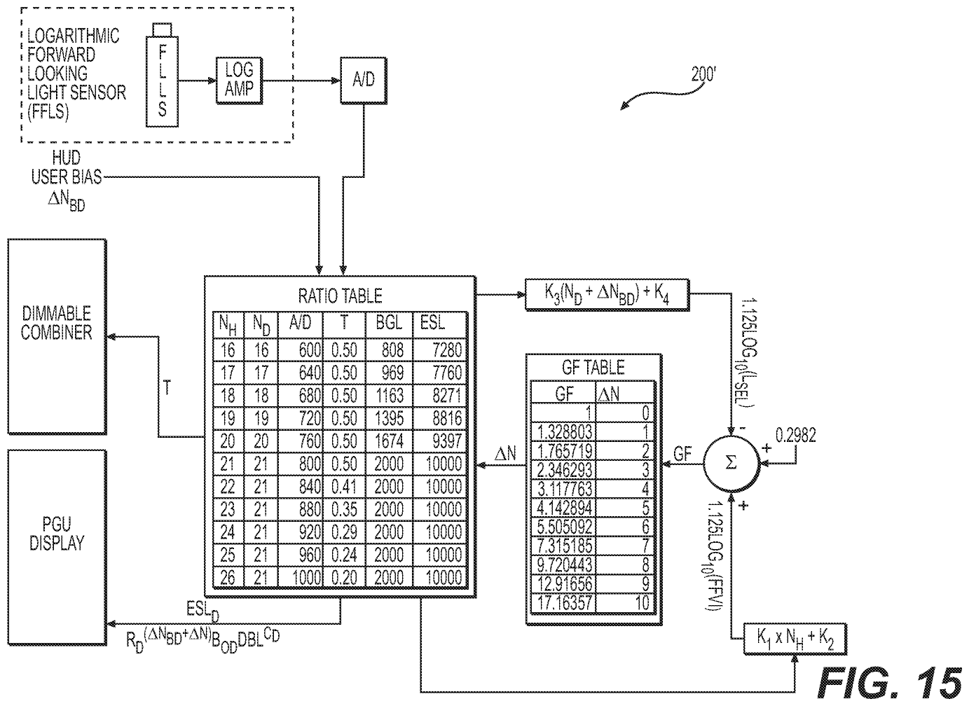

According to one or more embodiments, an automatic luminance control system 200 is shown in FIG. 14 using logarithmic light sensors instead of linear light sensors. However automatic luminance control may be accomplished where the display luminance may be changed as a function of the lighting conditions instead of keeping the display luminance constant and changing the transmission of the dimmable lens 42. The automatic luminance control system shown in FIG. 14 may be modified to adjust both the HUD luminance and the combiner transmission instead of the display and is shown in FIG. 15. Additionally, the automatic luminance control system shown in FIG. 15 may include a driver selection of a bias by a selected number (ΔN_{BD}) of transmission ratios. Additionally, the automatic luminance control system 200′ shown in FIG. 15 may illustrate that after the picture generation unit (PGU) luminance cannot be increased further, the HUD step number NH may continue to be modified by increasing the dimming level.

According to one or more embodiments, a LC dimming cell (dimmable element 42) may be utilized to change the combiner 38 transmission so that the HUD image may be visible under high ambient lighting conditions. The LC dimming cell may include an accurate control of the transmission rate by using one or more feedback control systems. The transmission rate may be controlled manually by the driver 14 or by an automatic control system using light sensors. In the manual embodiment, the control look up tables may be organized as constant step transmission step ratios in order to provide a linear visual perception to the logarithmic nature of the human eye response. Automatic control systems may use only a forward looking light sensor. The use of logarithmic light sensors may be desirable due to the working lighting range of the vehicle 12 and also due to the transmission step ratio tables.

According to one or more embodiments, an automatic control system may include a feedback control system to control the transmission rate of the dimming cell using a light source and light sensor. The automatic control system may include an automatic dimming control function that uses a logarithmic sensor to address a dynamic range. The automatic control system may also include a dimming ratio generated so that the steps between the successive levels appear to be equal to the driver 14. The automatic control system may include a table generated such that equal logarithmic light sensor delta values may correlate to successive dimming ratio steps. The automatic control system may include an allowance of a driver bias with adjustment dimming step ratios that may appear equal to the driver 14. The automatic control system may include a forward looking gain function to address the problem of display adaptation. The automatic control system may include a seamless transition between automatic luminance control of the PGU and the combiner transmission ratio control.

Many modifications and variations of the present disclosure are possible in light of the above teachings and may be practiced otherwise than as specifically described while within the scope of the appended claims.

What is claimed is:

1. A dimmable head up display system, the system comprising:
a combiner configured with a semi-transparent mirror to reflect light projected by a first light source; and
a dimmable element disposed adjacent to the combiner and opposite the semi-transparent mirror, the dimmable element configured to reduce the transmission of light reflected by the combiner through the dimmable element,
wherein the dimmable element includes a control system configured to reduce the transmission of light reflected by the combiner according to a plurality of light transmission reduction steps,
wherein the control system includes a feedback control system configured to adjust the transmission of light through the dimmable element based on at least a light sensor and the first light source measuring light transmission through the dimmable element.

2. The dimmable head up display system of claim 1, wherein the combiner emits a constant level of display luminance.

3. The dimmable head up display system of claim 1, wherein the plurality of light transmission reduction steps are spaced according to a predetermined ratio, wherein the predetermined ratio is determined using at least a minimum transmission level of the dimmable display lens and a maximum transmission level of the dimmable display lens.

4. The dimmable head up display system of claim 1, wherein the dimmable element is one of a suspended particle device, an electrochromic liquid crystal device, or a dye-doped guest-host liquid crystal device.

5. The dimmable head up display system of claim 1, wherein the control system includes a second light source disposed adjacent to the semi-transparent mirror of the combiner, opposite of the dimmable element, the second light source configured to emit light through the semi-transparent mirror, the combiner, and the dimmable element to the light sensor disposed on the dimmable element, opposite of the combiner, the light sensor configured to receive the light emitted by the second light source to determine the transmissivity of the dimmable element.

6. The dimmable head up display system of claim 1, wherein the control system includes a second light source disposed adjacent to the dimmable element, opposite of the combiner, the second light source configured to emit light through the dimmable element, the combiner, the light reflected by the semi-transparent mirror toward the light sensor, the light sensor disposed on the dimmable element, opposite the combiner, the light sensor configured to receive the light emitted by the second light source to determine the transmissivity of the dimmable element.

7. The dimmable head up display system of claim 1, wherein the control system includes a second light sensor disposed adjacent to the dimmable element, opposite of the combiner, the second light sensor configured to receive ambient light that passes through the dimmable element and the combiner, and is reflected by the semi-transparent mirror to the second light sensor to determine the transmissivity of the dimmable element.

8. The dimmable head up display element of claim 1, wherein the control system includes a second light sensor disposed adjacent to the semi-transparent mirror, opposite of the combiner, the second light sensor configured to receive ambient light that passes through the dimmable element and the combiner to determine the transmissivity of the dimmable element.

9. The dimmable head up display system of claim 1, wherein the control system includes a proportional integral derivative (PID) controller, wherein the PID controller is configured to adjust the voltage of the dimmable element to change a light transmission rate of the dimmable element.

10. The dimmable head up display system of claim 9, wherein the PID controller compares a measured feedback transmittance of the dimmable element to a requested transmittance of the dimmable element, and determines a transmittance error that is used to adjust a luminance of the dimmable element such that the emission of light from the combiner is dimmed according to the requested transmittance.

11. A method of dimming a heads up display (HUD), the method comprising:
reflecting light projected by a first light source in a combiner having a semi-transparent mirror;
measuring, using a light sensor, a transmission of light projected by the first light source through a dimmable element adjacent to the combiner and opposite the semi-transparent mirror;
comparing the measured transmission of light to a preset light transmission value; and
reducing the transmission of light through the dimmable element to the preset light transmission value.

12. The method of claim 11, wherein the reducing includes using a control system to reduce the transmission of light according to a plurality of light transmission steps.

13. The method of claim 12, wherein the using the control system includes using a feedback control system for adjusting the transmission of light through the dimmable element based on at least the light sensor and the first light source measuring light transmission through the dimmable element.

14. The method of claim 12, further comprising emitting a constant level of display luminance by the combiner.

15. The method of claim 12, further comprising spacing the plurality of light transmission reduction steps according to a predetermined ratio, wherein the predetermined ratio is determined using at least a minimum transmission level of the dimmable display lens and a maximum transmission level of the dimmable display lens.

16. The method of claim 13, the control system includes using a second light source disposed adjacent to the semi-transparent mirror of the combiner, opposite of the dimmable element, the second light source configured to emit light through the semi-transparent mirror, the combiner, and the dimmable element to a second light sensor disposed on the dimmable element, opposite of the combiner, the second light sensor configured to receive the light emitted by the second light source to determine the transmissivity of the dimmable element.

17. The method of claim 13, further comprising adjusting, by the control system, of a proportional integral derivative (PID) controller, the PID controller configured to adjust the voltage of the dimmable element to change a light transmission rate of the dimmable element.

18. A non-transient computer readable medium containing program instructions for causing a computer to perform the method of:
reflecting light projected by a first light source in a combiner having a semi-transparent mirror;
measuring, using a first light sensor, a transmission of light projected by the first light source through a dimmable element adjacent to the combiner and opposite the semi-transparent mirror;
comparing the measured transmission of light to a preset light transmission value; and
reducing the transmission of light through the dimmable element to the preset light transmission value.

19. The non-transient computer readable medium containing program instructions of claim 18 further comprising emitting a constant level of display luminance by the combiner.

20. The non-transient computer readable medium containing program instructions of claim 18 further comprising spacing the plurality of light transmission reduction steps according to a predetermined ratio, wherein the predetermined ratio is determined using at least a minimum transmission level of the dimmable display lens and a maximum transmission level of the dimmable display lens.
